(19) United States
(12) Patent Application Publication
(10) Pub. No.: US 2008/0145133 A1
(43) Pub. Date: Jun. 19, 2008

(54) INTERCHANGEABLE COSMETIC PACKAGE ELEMENTS

(76) Inventor: Barbie Palmer, Toronto (CA)

Correspondence Address: DIMOCK STRATTON LLP, 20 QUEEN STREET WEST SUITE 3202, BOX 102, TORONTO, ON, M5H 3R3, omitted

(21) Appl. No.: 11/565,052

(22) Filed: Nov. 30, 2006

(51) Int. Cl. B43K 27/02

(52) U.S. Cl. 401/18

(57) ABSTRACT

A cosmetic container consisting of a sealable package element that may be connected to other package elements to form an assembly of cosmetic packages. The container permits the combination and substitution of package elements within the assembly. In a preferred embodiment, the package elements may be oriented in either direction within the assembly, irrespective of the location or orientation of adjacent elements.

### FIELD OF THE INVENTION

The present invention is directed towards cosmetics packages. More specifically, the present invention is directed to individual cosmetic packages they may be combined with one another to form an implement for applying cosmetics.

### BACKGROUND OF THE INVENTION

It is well know that cosmetics need to be re-applied throughout the day during use. Further, it is well known that different colours and shades of make-up are worn at different times in the day. A person going out at night will typically apply a darker shade of make-up and may apply other highlights that would not be necessary in the day.

One problem with re-applying make-up in the day is that carrying full size cosmetic containers covering all of the cosmetics to be applied can be cumbersome. Prior attempts at providing portable cosmetics packages have included combining multiple portable cosmetic containers within a single assembly. Typically, these assemblies have comprised an elongated applicator that is made up of multiple cosmetic package elements that may be engaged or disengaged to expose individual cosmetics.

U.S. Pat. No. 3,592,202 (Jones) is directed towards a fingernail polish kit that comprises a tube, one end of the tube containing nail polish remover and the other end containing nail polish and the applicator brush container. The central portion of the tube may contain a wiping material, such as cotton to assist with the manicuring process. The limitation of this process is that only two cosmetic package elements may be connected with the tube, one at each end.

An improvement of the Jones assembly was described in U.S. Pat. No. 5,881,742 (Hunsberger). Huntsberger teaches an assembly with multiple tubes. Each tube serves to connect two cosmetic package elements and serves as a lid to protect the makeup. A second embodiment shows multiple cosmetic package elements, each element including a hollow base for receiving another cosmetic package element. The limitation of this package design is that cosmetic package elements are not interchangeable in order as the base of one element is used as the cover of a connecting element. The elements are not interchangeable as many types of cosmetics are not mixable, due to material compatibility issues. In the first embodiment, adjacent makeup elements share the same cover. In the second embodiment, once a cosmetic package element has been introduced into the base of an adjacent element, it should not be replaced with a different element to avoid mixing or contamination of the cosmetics. While the Huntsberger assembly may be acceptable for powder or other solid cosmetics, it would not be suitable for other liquid or paste cosmetics such as mascara, foundation or lipstick. An additional limitation is that the length of the assembly will change depending upon which element is being used, as opposed to the preference of the user. For instance, the last package element has no adjoining elements connected to its base, whereas the first package element must have all of the elements connected to its base.

U.S. Pat. No. 6,637,963 (Huang) discloses a cosmetic package assembly that is suitable for liquid or paste cosmetics. Huang discloses a single arrangement assembly, wherein the central cosmetic package assembly includes two cosmetic applicators arranged back to back. A cover or reservoir, for each of the applications is formed integrally with the base of the end cosmetic package elements. A limitation of the Huang assembly is that individual elements are combined in a fixed relationship and individual elements cannot be easily combined, exchanged or removed. Thus, a user is not able to exchange individual elements to select preferred shades or makeup types. Furthermore, only the full assembly may be used as the applicator with the end elements.

U.S. Pat. No. 6,568,529 (McMurrey) discloses a nestable cosmetic package assembly. Similar to Hunsberger, the base of each cosmetic package element forms the cover for the adjacent interconnecting element. A separate plug may be provided for the base of the end element.

All of these elements suffer from two distinct disadvantages. First, the individual cosmetic package elements can only be rearranged or exchanged where compatible cosmetics are contained in alternate elements. Second, the length of the assembly is fixed since removing an element deprives the assembly of a cover to seal the cosmetic contained within the adjacent element.

There thus exists a need for a cosmetic package assembly that permits a user to change the composition of the makeup products contained within the assembly.

There thus exists an additional need for a cosmetic package assembly that permits a user to change the number of cosmetic package elements in the assembly, and subsequently the size of the assembly.

There thus exists a further need for a cosmetic package assembly that overcomes the limitations of the prior art and allows for the interchange and exchange of individual cosmetic package elements.

### BRIEF DESCRIPTION OF THE DRAWINGS

In drawings which illustrate by way of example only a preferred embodiment of the invention,

FIG. 1 is an isometric view illustration of an individual cosmetic package element according to an embodiment of the present invention.

FIG. 2a is a side section view illustration of a first embodiment of the cosmetic package element with the closure connected to the container to seal the container.

FIG. 2b is a side section view illustration of a second embodiment of the cosmetic package element with the closure connected to the container to seal the container.

FIG. 3a is a side section view illustration of the first embodiment of the cosmetic package element with the closure separated from the container.

FIG. 3b is a side section view illustration of the second embodiment of the cosmetic package element with the closure separated from the container.

FIG. 4a is a side section view illustration of a first cosmetic package assembly embodiment of the present invention comprised of 5 cosmetic package elements.

FIG. 4b is a side section view illustration of an alternate cosmetic package assembly embodiment of the present invention comprised of two cosmetic package elements.

FIG. 5a is an isometric illustration showing two package elements of an embodiment of the present invention.

FIG. 5b is an isometric illustration showing two package elements of an alternate embodiment of the present invention.

FIG. 6a is an isometric illustration of a cosmetic package assembly embodiment of the present invention including a sharpener.

FIG. 6b is an isometric illustration of an alternate sharpener embodiment.

FIG. 7a is an isometric illustration of a cosmetic package element embodiment containing a liquid cosmetic and an applicator.

FIG. 7b is a side section view illustration of a cosmetic package element embodiment containing a liquid cosmetic and an applicator.

FIG. 8 is an isometric and section view illustration of a cosmetic package element embodiment containing a paste or powder cosmetic and an applicator.

FIG. 9a is an isometric view illustration of a cosmetic package assembly embodiment of the present invention including a central package element.

FIG. 9b is an isometric magnified view illustration of the central package element.

FIG. 10a is an isometric view illustration of a further embodiment of a cosmetic package assembly embodiment of the present invention comprised of further cosmetic package elements.

FIG. 10b is a side view illustration of the further cosmetic package element.

FIG. 11 is an isometric view illustration of a further embodiment of the cosmetic package element of the present invention.

### DETAILED DESCRIPTION OF THE INVENTION

In an embodiment the present invention provides a package element for storing a cosmetic, the element comprising a cosmetic container comprising a container element connector and a container closure connector; and, a container closure comprising a complementary element connector for connecting to the container element connector, and a complementary closure connector for connecting to the container closure connector to releasably seal the container closure to the cosmetic container; whereby the container element connector of a first package element may be connected to a complementary element connector of a second package element for connecting the cosmetic container of the first package element to the cosmetic closure of the second package element.

In a further aspect of the embodiment the second package element forms all or part of a handle for manipulating the first package element.

In yet a further aspect of the embodiment, a package element assembly may be provided comprising at least two package elements connected by connecting the element connector of the first package element with the complementary element connector of the second package element.

In yet a further aspect of the embodiment, a central package element may be provided for connecting to two package elements, the central package element comprising, a pair of container closures each comprising a container element connector, and one container closure comprising a container closure connector and the other comprising a complementary closure connector for connecting to the closure connector to releasably seal the central package element; whereby the container closures of the central package element may be combined with the complementary element connectors of the two package elements.

In yet a further aspect of the embodiment, a package element assembly may be provided comprising the central packet element connected to at least two package elements by combining the complementary element connector of a first package element with the element connector of the container and combining the complementary element connector of a second package element with the element connector of the container closure.

In an alternate embodiment the present invention provides a package element for storing a cosmetic, the element comprising, a cosmetic container comprising a container element connector, a complementary element connector and a closure connector, the complementary element connector adapted to connect with the container element connector, and, a container closure comprising a container element connector, a complementary element connector and a complementary closure connector for connecting to the closure connector to releasably seal the cosmetic container; whereby both the cosmetic container and the container element connector may be connected to either a container closure of another package element or a cosmetic container of another package element.

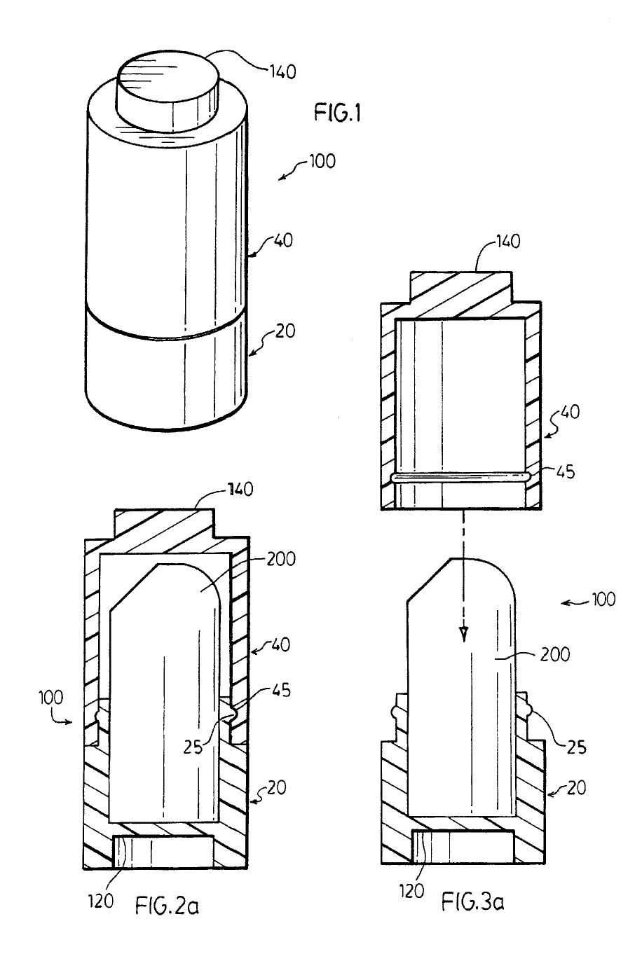

FIG. 1 illustrates an isometric view of an embodiment of a cosmetic package element according to the present invention. As will be appreciated, the figures are illustrations highlighting the workings of the present invention and are not intended to be scale drawings of an actual cosmetic package product. For instance, the element connectors and closure connectors

Referring to FIG. 1, an individual cosmetic package element 100 is comprised of a cosmetic container 20 and a container closure 40. The cosmetic container 20 includes an element connector 120 and the container closure 40 includes a complementary element connector 140. The outer configuration of the cosmetic container 20 and container closure 40 serves multiple functions: to aid in combining individual elements 100, to protect a cosmetic 200 or applicator 250 contained within the element 100, and to provide structural rigidity in combination with other elements 100 to comprise an assembly 300 that comprises an applicator suitable for applying a cosmetic 200 or employing an applicator 250 contained in the end element 100 of the assembly 300.

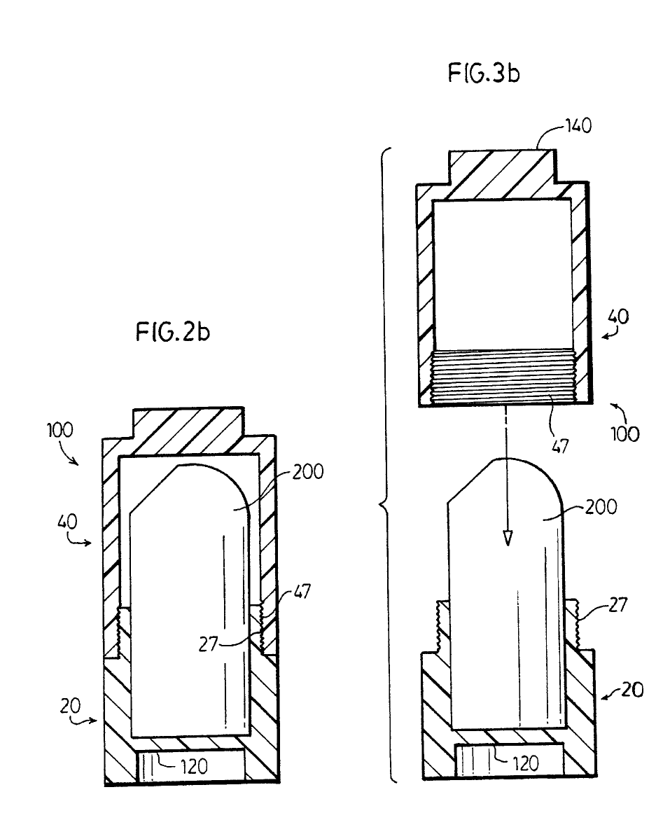

Referring to FIG. 2a, the cosmetic container 20 has a container closure connector 25 while the container closure 40 has a complementary closure connector 45 that may be connected to the container closure connector 25 to releasably seal the container. Preferably, the container closure connector 25 and complementary closure connector 45 are compatible with the choice of element connector 120 and complementary element connector 140. For instance, a press-connect type element connector 120 and complementary element connector 140 would be compatible with a threaded closure connector 27 and complementary closure connector 47, while a tongue and groove element connector 120 and complementary element connector 140 would be compatible with either a threaded closure connector 27 and complementary closure connector 47 or a press-fit container closure connector 25 and complementary closure connector 45. As will be appreciated, the terms container 20 and container closure 40 are relative terms, and the orientation of a container 20 and container closure 40 within a makeup assembly need not be fixed. That is, a first element 100 may be oriented with a container closure 40 having a complementary element connector 140, while a second element could be oriented with a container closure 40 having an element connector 120. While it is preferred to consistently locate a cosmetic 200 in a container 20 having an element connector 120 and sealed by a container closure 40 having a complementary element connector 140, the consistent orientation of locating the cosmetic 200 in the container 20 is not a requirement of the invention, and the cosmetic 200 may located in the container closure 40 without departing from the spirit of the invention. This orientation may be convenient where an applicator 250 may be preferably provided with an element connector 120 for ease of use in an assembly 300.

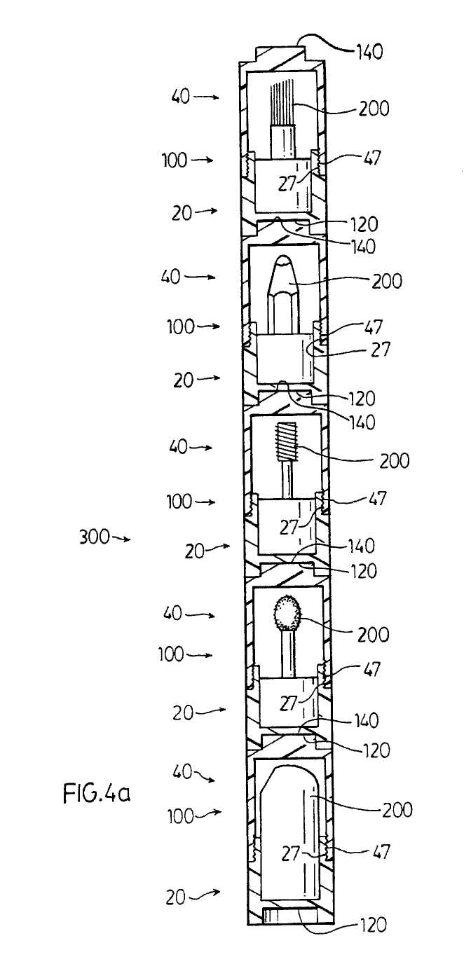

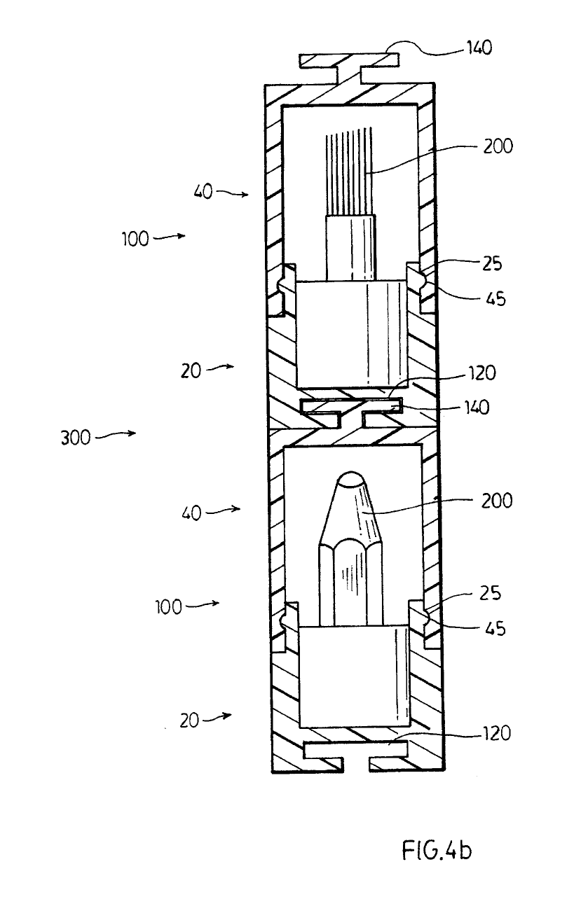

While the invention is depicted having lipstick as the cosmetic 200, it will be apparent that other cosmetics and applicators may be substituted in place of lipstick as the cosmetic 200. For instance, without limitation, the cosmetic 200 may comprise a lipstick, mascara, nail polish, eye liner, foundation, perfume, brush, applicator, clipper, eye lash curler, pencil, or other beauty product. Further, the figures are included for illustrative means only and are not meant to limit the cosmetics depicted to the type, configuration or scale shown. For instance, the lipstick is shown as being a solid stick of cosmetic and a pencil is shown in FIG. 4a in a non-scale fashion.

As will be apparent, since each element 100 includes its own container closure 40, all elements 100 may be interchangeably assembled adjacent to one another regardless of the compatibility of the particular cosmetic 200 in a first element 100 with the cosmetic 200 in the adjacent element 100. Thus contamination of one cosmetic 200 with another cosmetic 200 is avoided. Moreover, the elements 100 are only unsealed, thus exposing a cosmetic 200, when a user intends to apply the cosmetic 200.

FIG. 3a illustrates the closure of container closure 40 onto cosmetic container 20. The container closure 40 releasably seals the cosmetic 200 or cosmetic applicator 250 housed within the cosmetic container 20. Preferably, the container closure 40 forms an airtight seal with the cosmetic container 20 when engaged, such that the engaged container closure 40 and cosmetic container 20 form a compartment suitable for storing cosmetics. In a preferred embodiment illustrated in FIGS. 2b and 3b, the seal is achieved by a closure connector comprised of complementary threads 27 and 47 in the container closure 40 and cosmetic container 20. Alternatively, where compatible with the interconnect mechanism, the seal may be achieved either by complementary threads 27 and 47 or a press-fit seal 25 and 45.

Referring to FIG. 4a, multiple cosmetic package elements 100 may be combined to form a cosmetic package assembly 300. In the cosmetic package assembly embodiment shown in FIG. 4a, the assembly is formed by press-connecting the element connector 120 in the cosmetic container 20 with the complementary element connector 140 in the adjacent container closure 40. Since each cosmetic package element 100 has its own container closure 40, the order of the cosmetic package elements 100 within the cosmetic package assembly 300 is not fixed and may change.

FIG. 4b illustrates a similar cosmetic package assembly 300 in which the element connectors 120 and 140 are tongue and groove connections. The cosmetic container 20 and container closure 40 in this embodiment are shown with a press-fit seal 25 and 45.

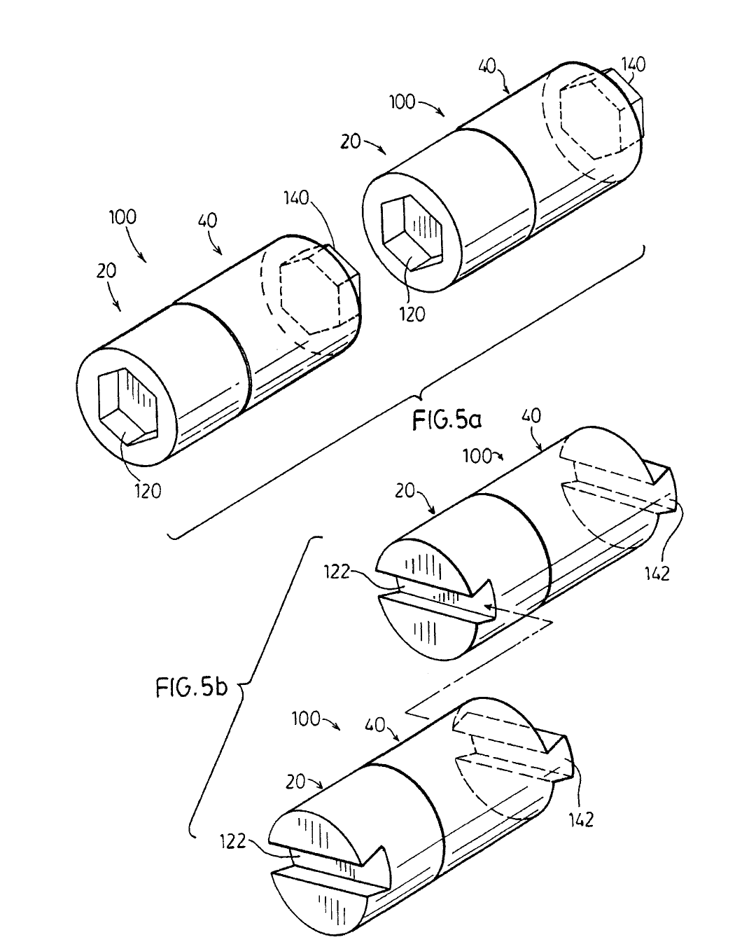

FIGS. 5a and 5b are isometric illustrations of the connection process according to two embodiments of the present invention. FIG. 5a illustrates a press-connect arrangement in which elements 100 are combined by pressing a male element connector 140 into a complementary female element connector 120. As depicted in FIG. 5a, the press-connect shape is preferably one that resists rotation of the elements 100 when connected. This is preferred where the releasable seal consists of threads 27 and 47 to avoid adjacent elements rotating instead of the container closure 40 and container 20 of the makeup element 100 being opened. While it is possible for a user to grip only a container closure 40 and corresponding container 20 when opening or closing an element 100, it is preferred to have element connector 120 and complementary element connector 140 that resist rotation for ease of use.

While a circular press-connect could provide sufficient resistance to rotation by friction alone, a non-circular shape is preferred as it eliminates the risk of slippage between elements 100 when a threaded closure connector 27 and 47 is used. The press-connect element connector 120 and complementary element connector 140 illustrated in FIG. 5a is by way of example only and may also comprise other shapes that resist the relative rotation of an element connector 120 with a connector 140, and the invention is not intended to be limited the embodiment illustrated. As will be appreciated, the location of element connector 120 and 140 may be reversed to provide for a connector 120 on a container closure 40 and a connector 140 on a container 20 without departing from the intent of the invention.

FIG. 5b illustrates an alternate interconnection that comprises a sliding connection with a dovetail groove element connector 122 and tongue complementary element connector 142. Preferably the connectors provide a detent, snap or other locking mechanism (not shown) to lock adjacent elements 100 into alignment with one another when they are connected to comprise an assembly 300.

In an embodiment the groove element connector 122 may terminate short of the sidewall of the element 100. In this embodiment, the groove element connector 122 and tongue complementary element connector 142 may only be interconnected in a single sliding direction and removed by reversing the sliding direction. An advantage of this embodiment is that the elements 100 are more securely interconnected, and the locking mechanism is only required to resist motion in a single direction. As will be appreciated, similar to the press-connect interconnection, the relative location of the groove element connector 122 and tongue complementary element connector 142 and on the container closure 40 and container 20 may be reversed without departing from the intent of the invention.

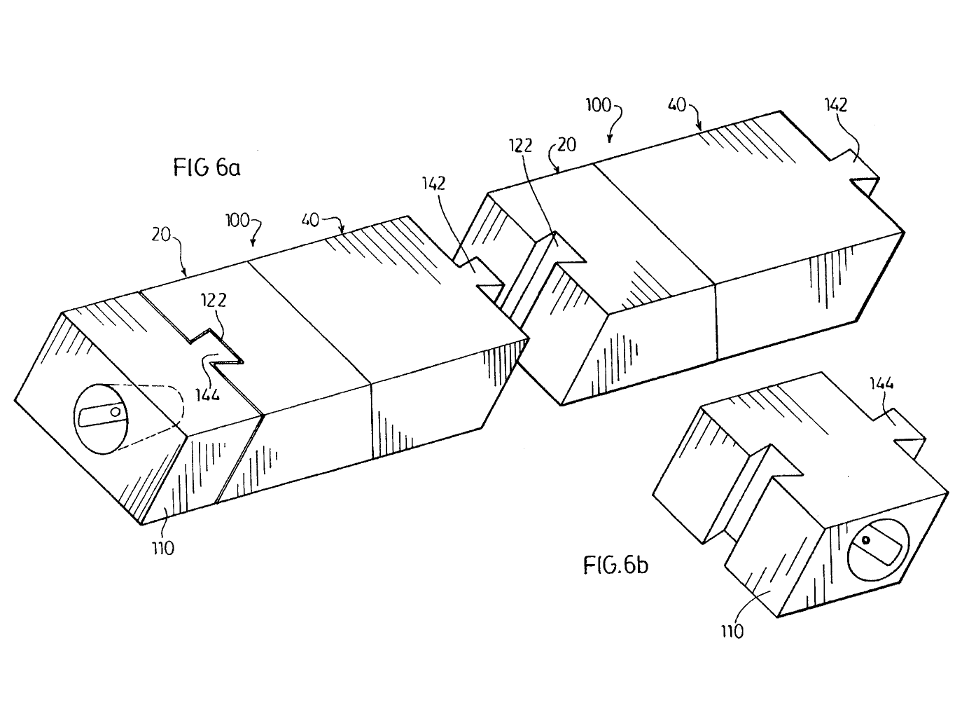

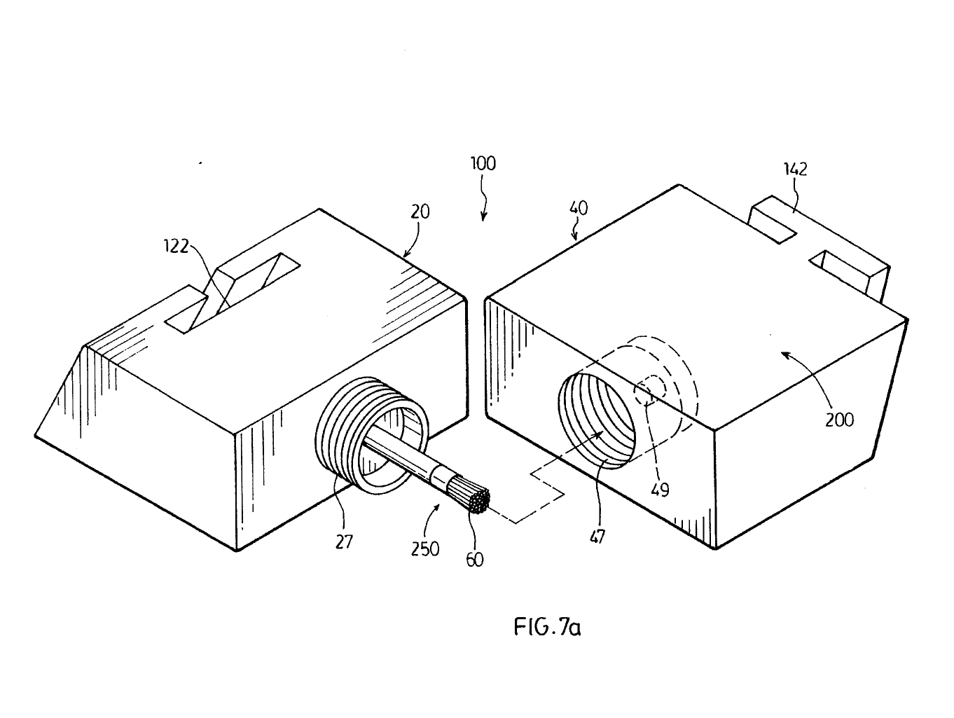

FIG. 6a is an isometric illustration of an alternate embodiment featuring squared elements 100 with slanted ends of the container closure 40 and cosmetic container 20. In the embodiment illustrated in FIG. 6a the interconnection is by way of a groove element connector 122 and tongue complementary element connector 142. In this embodiment the element connector 122 and complementary element connector 142 may be a dovetail, a T-shape, or other suitable tongue and groove connection. The end element of FIG. 6a is shown as a sharpener 110. The sharpener 110 may either comprise an end element with only a single connector 122, or alternatively may be provided with a connector on each end and a sharpener entry located on a side of the sharpener 110, as shown in FIG. 6b.

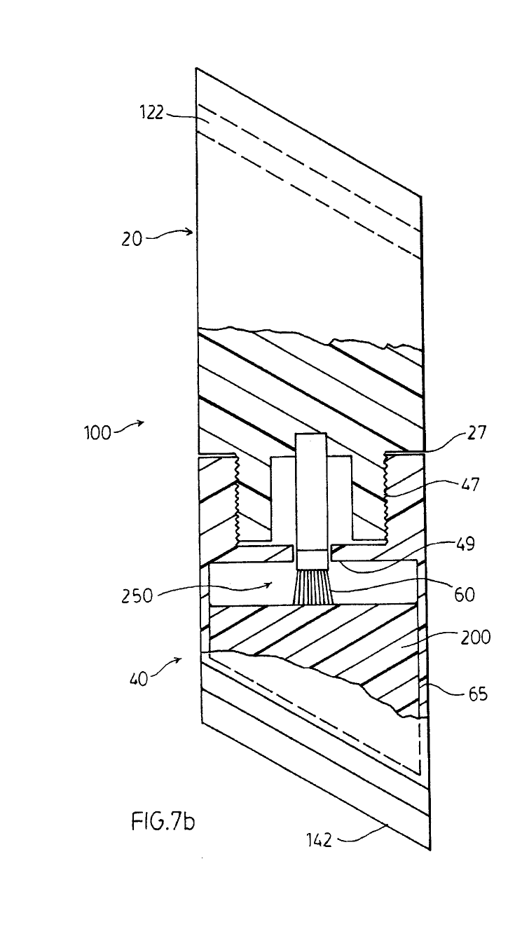

The configuration of a container closure 40 and container 20 for a particular element 100 may vary internally, while maintaining the same exterior configuration. Specifically, the internal configuration of a container closure 40 and container 20 may be adapted to house a specific cosmetic 200. For instance, FIGS. 7a and 7b illustrate an embodiment where the element 100 comprises a container 20 that comprises a reservoir 65 for storing a liquid cosmetic 200, and a container closure 40 that comprises an applicator 250. In the embodiment shown, the applicator 250 is a nail polish brush 60 and the cosmetic 200 is nail polish contained within the reservoir 65. In the embodiment shown, the container closure 40 includes an opening 49 of reduced size to accommodate the nail polish brush 60 and use the shaft of the brush 60 to stopper the reservoir. Thus, while the external configuration of the elements 100 is preserved, the internal configuration may be adapted as necessary, to accommodate and preserve the cosmetic 200 contained therein. As indicated above, the relative location of the applicator 250 and the reservoir 65 is for descriptive purposes and is not intended to be limiting.

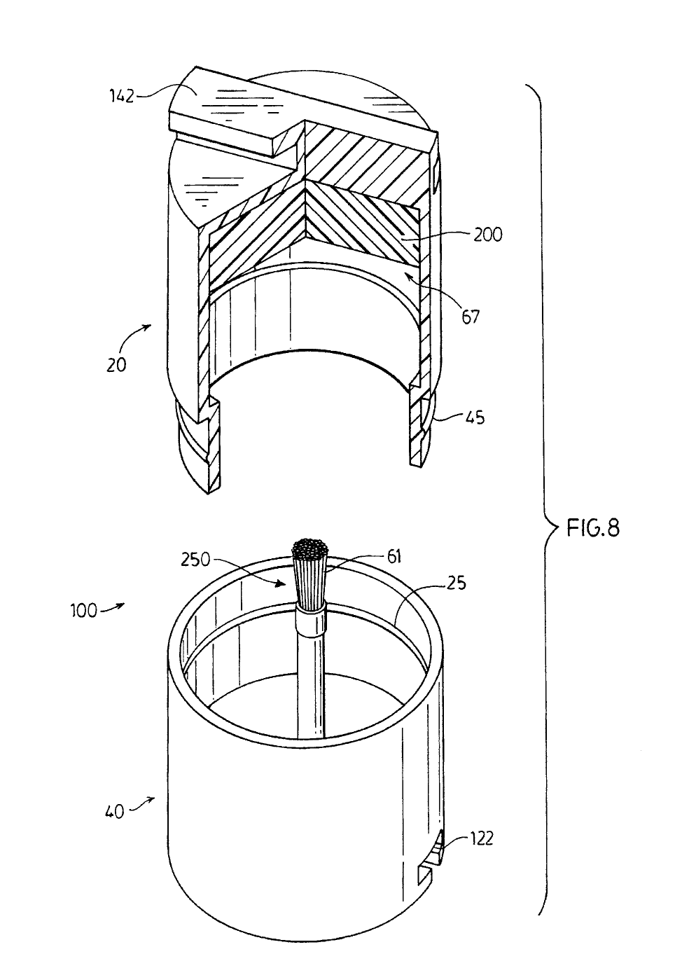

FIG. 8 is an isometric and isometric cutaway of an embodiment of element 100 containing a cosmetic 200 and applicator 250. In the embodiment of FIG. 8, the cosmetic container 20 comprises a reservoir 67 for storing a powder cosmetic, and the closure 40 comprises an applicator 250 that in the embodiment shown is a powder brush 61.

In operation a cosmetic package element 100 according to the present invention permits the creation of a customized cosmetic package assembly 300 by the user containing specific cosmetics 200 suitable for that particular day or event. Furthermore, in operation, the order of the cosmetic package elements 100 may be interchanged within the cosmetic package assembly 300 in order to facilitate application of a particular cosmetic 200. For instance, a cosmetic package assembly comprised of four cosmetic package elements 100 may be employed by a user to apply each of the cosmetics 200 in turn after interchanging the current applied cosmetic 200 with the next element 100 in the assembly. In this manner, each cosmetic package element 100 is provided with the benefit of being located at the end of the cosmetic package assembly 300. In other words, each cosmetic package element 100 may take its turn as the end element 100 in the cosmetic package assembly 300 that comprises a cosmetic applicator or handle for manipulating the end element 100.

For storage and transportation of the cosmetic package assembly 300, it thus becomes possible to separate the cosmetic package assembly 300 into smaller cosmetic package assemblies or simply into a collection of individual elements 100 during transport, and reconstituting or connecting the individual elements 100 together to form an elongated cosmetic package assembly 300 for application of a cosmetic 200. Alternatively, an individual cosmetic package element 100 may be removed from the assembly 300 if it would be simpler to apply the cosmetic 200 without the element 100 being attached to the assembly 300. For example, lipstick is a cosmetic 200 that is typically applied in a small hand-held applicator and might by difficult or ungainly to apply if the lipstick element 100 is required to remain connected to the rest of the assembly 300 during application. A cosmetic package element 100 of the present invention containing lipstick may be removed from a cosmetic package assembly 300 for application, without exposing the cosmetic 200 in an adjacent cosmetic package element 100. Alternatively, element 100 may be connected to a second element 100 to comprise a shortened assembly 300 for applying the cosmetic 200.

In an alternate embodiment, one or more of the elements 100 or sharpener 110 may be provided with a reflective exterior on at least a portion of their exterior surface. The reflective exterior may be used by a user when utilising one of the elements 100. For instance, an element 100 that comprises a lipstick may be removed from an assembly 300 for application by a user. The user may employ the reflective exterior of the remainder of the assembly 300 as a mirror to aid in applying the lipstick. Since the lipstick element 100 may be removed from the assembly 300 without exposing the adjacent cosmetic 200, some or all of the remainder of the assembly 300 can be usefully used by the user to assist in applying the lipstick.

Conversely, if a user wished to apply a lip-liner, or a lip outline pencil, then the liner or pencil element 100 could be substituted for the end element 100 in the assembly 300, for application, or could be separated as a two element 100 assembly 300 for convenience of application. In this manner, the connection of individual cosmetic package elements 100 to form an assembly 300 may be performed where convenient for transportation or application of a cosmetic 200. However, a user is afforded the convenience of transporting or applying a cosmetic 200 as either an individual element 100 or an abbreviated assembly 300 where application is aided by the addition of one or more elements 100 but the complete assembly 300 would be ungainly.

In circumstances where a user has a particular function or event for which they need a cosmetic 200, a customized cosmetic package assembly 300 may be created by selecting suitable elements 100. Thus, if the user is traveling for the day but is planning to go out at night, the user may apply their day makeup at home and combine a cosmetic package assembly 300 comprised of a day lipstick, an evening lipstick and evening makeup. Thus, while traveling, the user may apply or re-apply the daytime lipstick as required and still use the daytime cosmetic package element 100 as an element 100 of a cosmetic package assembly 300 when applying the evening makeup. In this fashion, a user is able to select the number and type of elements 100 particularly suited for their needs on any particular day.

Similarly, if the cosmetic supply in an individual cosmetic package element 100 is exhausted, the user is able to replenish that individual cosmetic package element 100 alone without having to replace the rest of the elements 100 in the assembly 300. This is particularly useful in circumstances where a user may frequently apply a particular cosmetic 200 and only seldom apply or reapply the cosmetic 200 contained in the other elements 100.

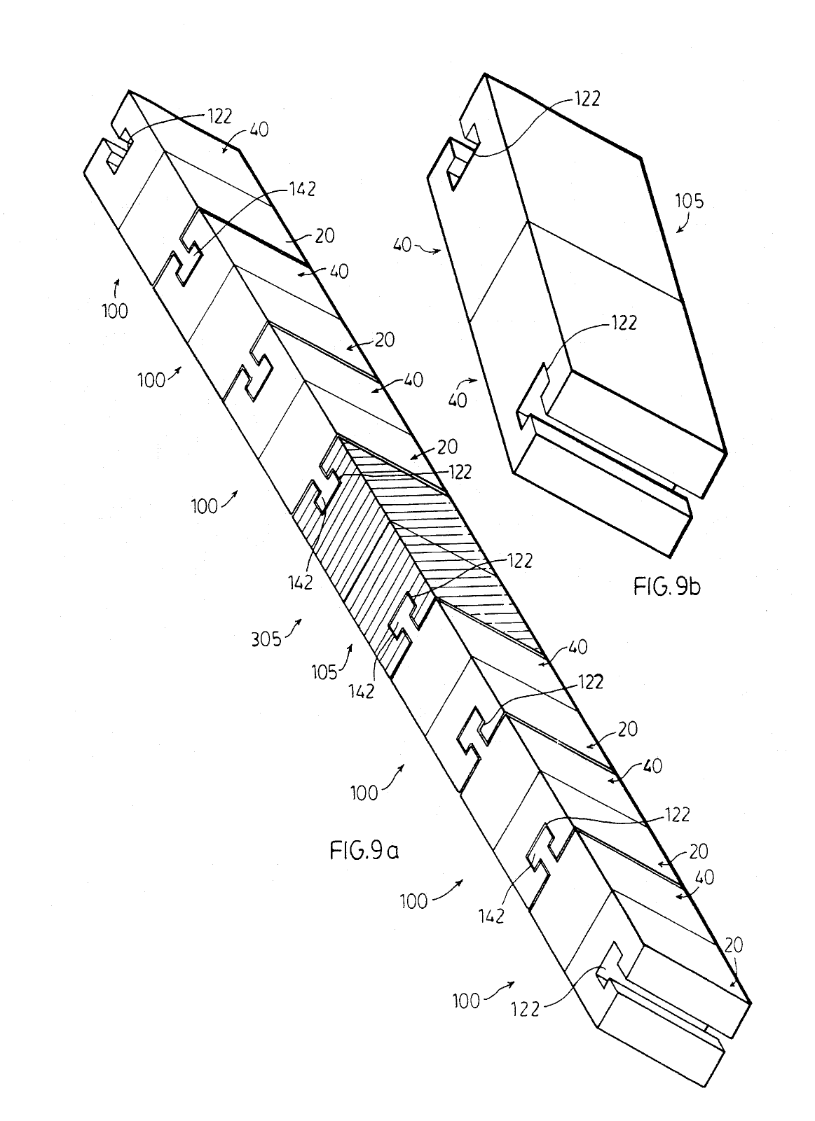

FIGS. 9a and 9b provide an alternate embodiment of the present invention in which an element 105 may be provided with either an element connector 120, 122 or a complementary element connector 140, 142 disposed at both ends of the element 105. The element 105 of the embodiment of FIGS. 9a and 9b provides a central connecting element 105 that permits the creation of an assembly 305 with a container closure 40 disposed at each end of the assembly 305. One of the container closures 40 comprises a closure connector 25, 27 and the other of the container closures 40 comprises a complementary closure connector 45, 47.

Preferably central connecting element 105 may be provided with a reflective surface on the exterior and/or may comprise a hollow chamber for storage. In an alternate embodiment, element 105 may comprise a container 20 and a container closure 40, where both comprise either an element connector 120, 122 or a complementary element connector 140, 142.

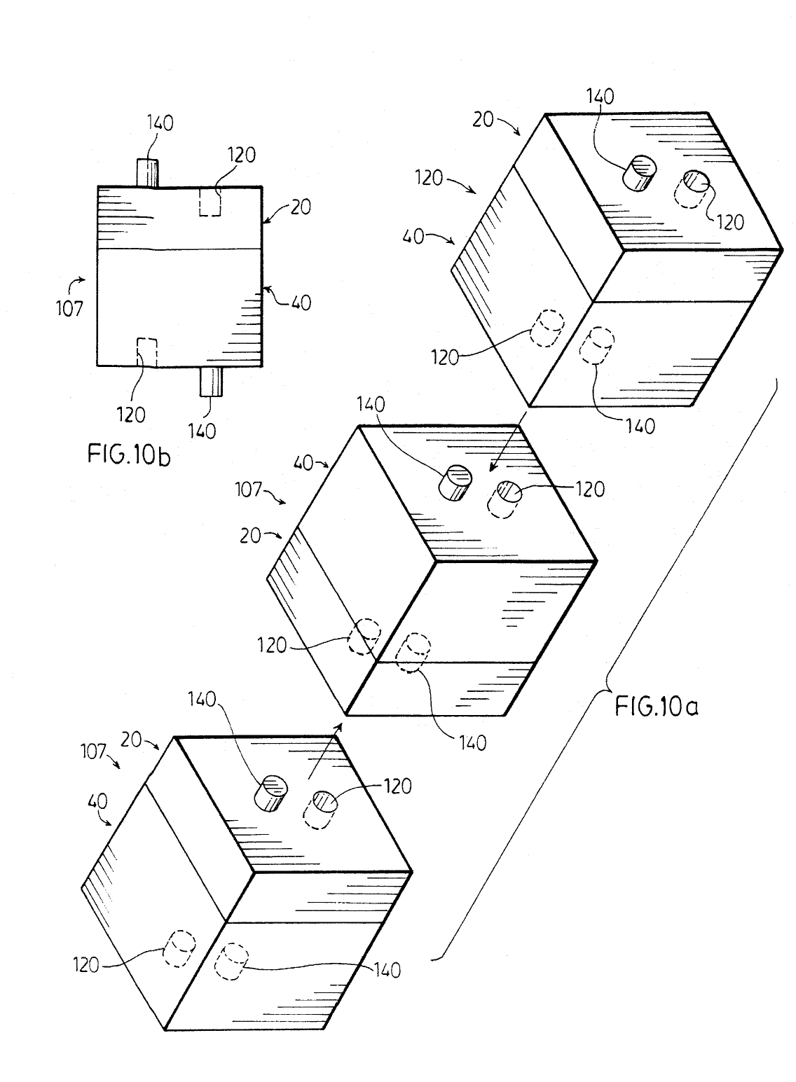

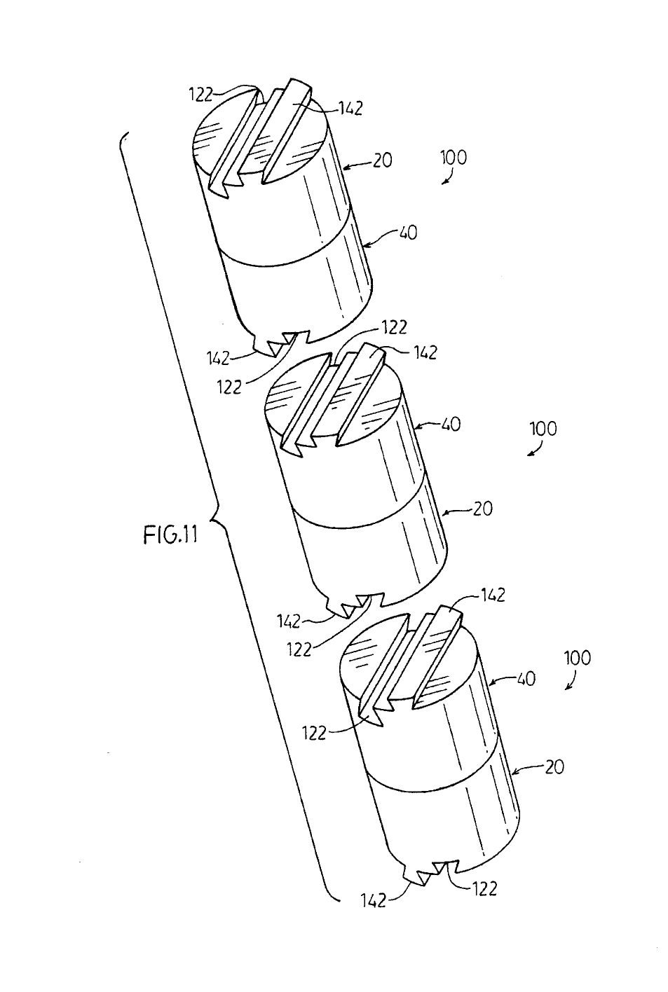

As illustrated in FIGS. 10a, 10b and 11, a further embodiment provides a cosmetic package element 107 with both an element connector 120, 122 and a complementary element connector 140, 142 located on each end of the element 107. The use of both types of connectors on each of the cosmetic container 20 and container closure 40 permits independent orientation of each element 105 within an assembly of elements 107. The embodiment of FIGS. 10a, 10b and 11 provides the additional advantage that either end of an assembly may comprise an element 107 oriented to dispose the container closure 40 facing outward. Unlike the embodiment illustrated in FIGS. 9a and 9b, no specific orientation of elements 107 is required to comprise such an assembly.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A package element for storing a cosmetic, the element comprising, a cosmetic container comprising a container element connector and a container closure connector; and,
a container closure comprising a complementary element connector for connecting to the container element connector, and a complementary closure connector for connecting to the container closure connector to releasably seal the container closure to the cosmetic container;
whereby the container element connector of a first package element may be connected to a complementary element connector of a second package element for connecting the cosmetic container of the first package element to the cosmetic closure of the second package element.

2. The package element of claim 1 wherein the second package element forms all or part of a handle for manipulating the first package element.

3. A package element assembly comprising at least two package elements of claim 1 connected by connecting the element connector of the first package element with the complementary element connector of the second package element.

4. A central package element for connecting to two package elements of claim 1, the central package element comprising,
a pair of container closures each comprising a container element connector, and one container closure comprising a container closure connector and the other comprising a complementary closure connector for connecting to the closure connector to releasably seal the central package element;
whereby the container closures of the central package element may be combined with the complementary element connectors of the two package elements.

5. A package element assembly comprising the central packet element of claim 4 connected to at least two package elements by combining the complementary element connector of a first package element with the element connector of the container and combining the complementary element connector of a second package element with the element connector of the container closure.

6. The package element of claim 1 wherein the element connector comprises a male connector and the complementary element connector comprises a female connector.

7. The package element of claim 6 wherein the element connector comprises a tongue and the complementary element connector comprises a groove.

8. The package element of claim 6 wherein the container closure connector and the complementary container closure connector comprise mating threads.

9. The package element of claim 6 wherein the element connector and complementary element connector are shaped to resist rotation.

10. The package element of claim 6 wherein the container closure connector and the complementary container closure connector comprise a press-fit connection.

11. A package element for storing a cosmetic, the element comprising,
a cosmetic container comprising a container element connector, a complementary element connector and a closure connector, the complementary element connector adapted to connect with the container element connector, and,
a container closure comprising a container element connector, a complementary element connector and a complementary closure connector for connecting to the closure connector to releasably seal the cosmetic container;
whereby both the cosmetic container and the container element connector may be connected to either a container closure of another package element or a cosmetic container of another package element.

12. The package element of claim 11 wherein the element connector comprises a male connector and the complementary element connector comprises a female connector.

13. The package element of claim 12 wherein the element connector comprises a tongue and the complementary element connector comprises a groove.

14. A package element assembly comprising at least two package elements of claim 11 connected by connecting the element connector and the complementary element connector of either the cosmetic container or the container closure of the first package element with the complementary element connector and the element connector of either the cosmetic container or the container closure of the second package element.

15. The assembly of claim 14 wherein the second package element forms all or part of a handle for manipulating the first package element.
